(19) United States
(12) Patent Application Publication
(10) Pub. No.: US 2011/0270505 A1
(43) Pub. Date: Nov. 3, 2011

(54) Prediction and estimation of the states related to misfire in an HCCI engine

(76) Inventors: Nalin Chaturvedi, Sunnyvale, CA (US); Christopher Mayhew, Union City, CA (US); Sungbae Park, Huissen (NL); Jasim Ahmed, Mountain View, CA (US); Aleksandar Kojic, Sunnyvale, CA (US); Hanho Song, Cupertino, CA (US); David Cook, Mountain View, CA (US); Karl Lukas Knierim, Stuttgart (DE)

(21) Appl. No.: 12/661,587

(22) Filed: Mar. 18, 2010

(51) Int. Cl. F02D 28/00

(52) U.S. Cl. 701/102

(57) ABSTRACT

A method for predicting and correcting an impending misfire in a homogeneous charge compression ignition (HCCI) engine includes: modeling HCCI engine operation in a nominal, steady-state operating region and in unstable operating regions bordering the steady-state operating region, using a zero-dimensional model; predicting an occurrence of an engine misfire based on the modeling of the HCCI engine operation; and providing a remedial corrective measure when an engine misfire is predicted. The remedial corrective measure includes one of: (a) late injection to avoid full combustion during a trapping cycle, and a reduction in amount of injected fuel to account for residual fuel of the previous cycle; or (b) earlier exhaust valve closing to trigger combustion of residual fuel within the trapping cycle, and a later injection and reduction of injected fuel to account for residual fuel of the previous cycle.

### BACKGROUND OF THE INVENTION

1. Field of the Invention

The present invention relates to a method of predicting a misfire before it occurs during operation of an HCCI engine so that preventive and/or remedial action may be taken.

2. Description of Related Art

Homogeneous charge compression ignition or HCCI is a combustion method that has been proposed for internal combustion engines. It is attractive in automotive applications, since HCCI can yield high efficiencies at partial loads (up to 30%) compared to a conventional spark ignited combustion. Furthermore, engines that run on HCCI also yield significantly reduced NOₓ emissions due to their low operating temperatures on an average. Some of these results have been reported. Essentially, HCCI involves a homogenized charge, which auto ignites due to compression within the combustion stroke. Thus, it combines the advantage of diesel-like combustion by including high compression ratios, while maintaining the low emissions observed in Gasoline engines due to the homogeneous charge. Historically, it was first encountered as a combustion mode in two-stroke engines and was later used in a four stroke engine. For an overview of research in HCCI and its potential, see K. Epping, S. Aceves, R. Bechtold and J. Dec, “The Potential of HCCI-Combustion for High Efficiency and Low Emissions,” SAE paper 2002-01-1923, 2002.

There are a couple of methods to induce an HCCI mode of combustion in the IC (internal combustion) engine. These include but are not limited to, heating of the intake manifold or pre-heating of induction gases, and retaining or re-inducting exhaust gases using either external exhaust gas recirculation (EGR) and/or internal EGR. Internal EGR can be realized through either rebreathing strategies, which involve reopening the exhaust valve after the top dead center of gas exchange, or by an early closing of the exhaust valve, called negative valve overlap, to trap residual hot gas within the cylinder.

Till recently, research in HCCI has mostly paid attention to steady-state operation with little attention to challenges involved with HCCI operation close to unstable regimes. Thus the dynamics of HCCI, within its nominal operating region, are well understood and control of HCCI at these points has been realized by various strategies (see R. Karrelmeyer, J Haring, W. Fischer, and J. P. Hathout: “Closed-loop control of a 1-cylinder gasoline HCCI-Engine in Dynamic Operation,” E-COSM—Rencontres Scientifiques de l'IFP, 2006; G. M Shaver: “Physically-Based Modeling and Control of Residual-Affected HCCI Engines using variable Valve Actuation,” PhD thesis, Stanford University, 2005; and J. Bengtsson, P. Strandh, R. Johansson, P. Tunestal and B. Johansson: “Model Predictive Control of Homogeneous Charge Compression Ignition (HCCI) Engine Dynamics,” IEEE International Conference on Control Applications, pages 1675-1680, 2006). While HCCI operation close to the borders of this stable operating region is both beneficial and necessary for practical implementation of HCCI, the control problems in this region remain a challenge since there does not even exist a reduced-order model for control purposes that describes behavior close to misfire region.

Though a wide range of models exist in the literature based on the application domain, most of the current control oriented zero dimensional models do not explicitly model the chemical kinetics of the combustion process and do not have a model for misfire when a disturbance is introduced in the steady-state operation.

Most current control strategies for HCCI (see, e.g., R. Karrelmeyer, J. Haring, W. Fischer, and J. P. Hathout: “Closed-loop control of a 1-cylinder gasoline HCCI-Engine in Dynamic Operation,” E-COSM—Rencontres Scientifiques de l'IFP, 2006; G. M Shaver: “Physically-Based Modeling and Control of Residual-Affected HCCI Engines using variable Valve Actuation,” PhD thesis, Stanford University, 2005; and J. Bengtsson, P. Strandh, R. Johansson, P. Tunestal and B. Johansson: “Model Predictive Control of Homogeneous Charge Compression Ignition (HCCI) Engine Dynamics,” IEEE International Conference on Control Applications, pages 1675-1680, 2006) focus on the control of the engine dynamics in the stable region away from the borders of instability. In this case, the engine is transitioned from a delayed combustion operation to a nominal combustion operation by feedback control. This process often involves a decrease of the EGR or a delay in the injection timing to prevent the advanced combustion within the next cycle. However, applying the same strategy in case of misfire is detrimental to bringing the engine back to stable combustion.

### BRIEF SUMMARY OF THE INVENTION

In accordance with the present invention, a new method is presented that captures the behavior of HCCI in case of disturbance-introduced misfire. This method involves a control oriented zero dimensional model that is able to capture both steady state behavior and misfire behavior of the engine.

Prediction of misfire and its avoidance is critical to safe and reliable operation of HCCI engines at low load. HCCI operation at low loads is beneficial, but difficult due to the presence of combustion instabilities. These instabilities cause the engine to misfire, thus stalling its operation. Prediction of misfire is the first step to avoiding it. In this invention, a strategy is presented that allows one to extrapolate information based on the initial state of an engine and allows one to predict if misfire will occur. If a misfire is predicted, one can take appropriate remedial measures to avoid it or compensate for it.

As noted above, most current control strategies for HCCI focus on the control of the engine dynamics in the stable region away from the borders of instability, in which case the engine is transitioned from a delayed combustion operation to a nominal combustion operation by feedback control, and this process often involves a decrease of the EGR or a delay in the injection timing to prevent the advanced combustion within the next cycle. However, applying the same strategy in case of misfire is detrimental to bringing the engine back to stable combustion, i.e., in case of misfire, instead of decreasing the amount of EGR, it is necessary to increase the amount of EGR to keep more thermal energy inside of the cylinder.

The method of the present application uses a modified Arrhenius integral threshold, a novel recursive mass flow equation to capture the effect of feedback from cycle-to-cycle and couple it with a thermodynamics model to capture the effect of partly burned fuel and misfires. Also presented is a model to predict the amount of fuel that is used if a misfire occurs. For illustration purposes, the strategy/method in the present application is compared to a high-fidelity model for misfire, presented in K. L. Knierim, Sungbae Park, J. Ahmed, A. Kojic, I. Orlandini and A. Kulzer: “Simulation of misfire and strategies for misfire recovery of gasoline HCCI,” Proceedings of the 2008 American Control Conference, pages 3947-3952, 2008. In “Simulation of misfire and strategies for misfire recovery of gasoline HCCI,” a model was presented which used a simplified chemical mechanism for the oxidation of iso-octane and n-heptane coupled with an airflow model, and the chemical kinetics were modeled using a detailed simulation software that was able to capture the effect of partly burned fuel or misfires.

### BRIEF SUMMARY OF THE SEVERAL VIEWS OF THE DRAWING

FIG. 1 is a diagram showing various processes that take place in a cycle of an engine.

FIG. 2 is a plot of an integrated Arrhenius reaction kinetic mechanism (IAR) versus the crank angle of an engine.

FIG. 3 is a plot of a fraction of fuel burned in a cylinder versus the integrated Arrhenius reaction kinetic mechanism for various data points.

FIG. 4 is a plot of an integrated Arrhenius reaction kinetic mechanism versus an engine crank angle, which shows combustion and non-combustion in a trapping phase.

FIG. 5 shows plots of cylinder temperature and pressure predicted by the model of the present Application and a CHEMKIN/Airflow model.

### DETAILED DESCRIPTION OF THE INVENTION

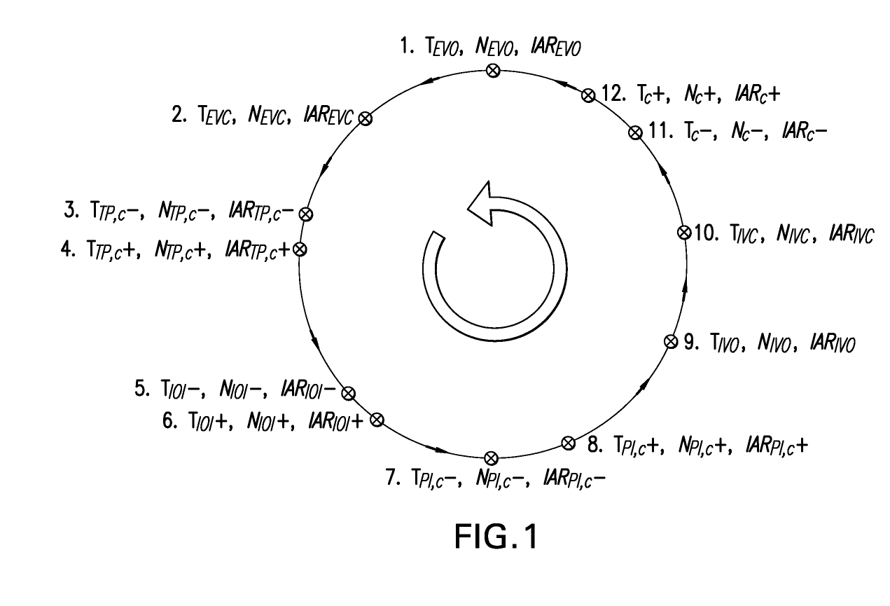

An engine cycle is shown in FIG. 1. The cycles in an engine repeat continuously in the direction shown in the figure. To predict misfire, certain states are tracked throughout the cycle and in particular, their values marked at each of the twelve points as shown in FIG. 1. These twelve points are:

1. Exhaust valve opening (EVO): This event corresponds to the crank angle at which the exhaust valve opens.

2. Exhaust valve closing (EVC): This event corresponds to the crank angle at which the exhaust valve closes.

3. Trapping phase, before combustion (TP,c⁻): This event corresponds to the instant just before 50% heat release (CA50) if there is combustion in the trapping phase. Otherwise, this event corresponds to the point just before the instant of injection in step 5. For a nominal engine cycle, there is no combustion in this phase and steps 3, 4 and 5 are identical.

4. Trapping phase, after combustion (TP,c⁺): This event corresponds to the instant just after CA50 or 50% heat release point, if there is combustion in the trapping phase. Otherwise, this event corresponds to the point just before the instant of injection in step 5. For a nominal engine cycle, there is no combustion in this phase and steps 3, 4 and 5 are identical.

5. Before instant of injection (IOI⁻): This event corresponds to the crank angle just before injection.

6. After instant of injection (IOI⁺): This event corresponds to the crank angle just after injection.

7. Post-injection/Pre-intake, before combustion (PI,c⁻): This event corresponds to the instant just before 50% heat release (CA50) if there is a combustion event in the post-injection and pre-intake phase. Otherwise, this event corresponds to the intake valve opening in step 9. For a nominal engine cycle, there is no combustion in this phase and steps 7, 8 and 9 are identical.

8. Post-injection/Pre-intake, after combustion (PI,c⁺): This event corresponds to the instant just after CA50 or 50% heat release point, if there is a combustion event in the post-injection and pre-intake phase. Otherwise, this event corresponds to the intake valve opening in step 9. For a nominal engine cycle, there is no combustion in this phase and steps 7, 8 and 9 are identical.

9. Intake valve opening (IVO): This event corresponds to the crank angle at which the intake valve opens.

10. Intake valve closing (IVC): This event corresponds to the crank angle at which the intake valve closes.

11. Before combustion (c⁻): In case of complete combustion, this event corresponds to the instant just before 50% heat release (CA50). In case of misfire, this corresponds to the crank angle at EVO in step 1.

12. After combustion (c⁺): In case of complete combustion, this event corresponds to the instant just after CA50 or 50% heat release point. In case of misfire, this step corresponds to the crank angle at EVO in step 1.

Note that steps {3, 4} and {7, 8} do not occur for a nominal engine operation and are identical to the subsequent steps.

Of the various states that are tracked, the two most important states are temperature T and the mole vector NεR⁵_{≧0} that denotes the vector of moles of the relevant chemical species present in the combustion chamber. Components of N are referred to as Nⁱ, where i∈{CₐH_{b}, O₂, N₂, CO₂, H₂O}. For instance, N^{N2} denotes the moles of N₂ in the cylinder. Another important state that is tracked is the integrated arrhenius rate (IAR), which shall be defined later.

To start the computation in an engine control unit (ECU), one can ideally begin from any point in the circle. However, for the purposes of this discussion, we consider step 1 as the starting point.

Mass Balance

In the context of engine misfire, an explicit mass balance becomes crucial for tracking the quantities of major species present in the cylinder. Implicit mass balance assumptions, like those made in G. M Shaver, M Roelle and J. C. Gerdes: “A two-input two-output control model of HCCI engines,” American Control Conference, Proceedings of the 2006, 2006, are no longer valid when a combustion produces a partial burn of fuel.

In the following mass balance, the engine is considered to be a batch process reactor with product recycling from cycle-to-cycle as follows.

1. N_{c}(k−1) denotes the mole vector after combustion on the previous cycle.
2. Some product is exhausted. The remaining, recycled, moles are denoted by Nᵣ(k).
3. The recycled product is mixed with additional fuel from injection and air from intake. This input is denoted as u(k) and Nₘ(k) denotes the mixed pre-combustion mole vector.
4. Combustion occurs according to the reaction stoichiometry (1). Partial burn is captured by the disturbance _{εc}(k)ε[0,1], where _{εc}(k)=0 indicates a complete combustion of fuel. The parameter φ(k)ε[0,1] is the ratio of fuel moles to the stoichiometric value. N_{c}(k) denotes the post-combustion mole vector.

φCₐH_{b}+(a+b/4)O₂→φε_{c}CₐH_{b}+(a+b/4)(1−φ(1−ε_{c}))O₂+aφ(1−ε_{c})CO₂+(b/2)φ(1−ε_{c})H₂O (1)

The mass balance is as follows:

Nᵣ(k)=β(k)N_{c}(k−1) (2)

Nₘ(k)=Nᵣ(k)+u(k) (3)

N_{c}(k)=P(ε_{c}(k))Nₘ(k), (4)

where ε(k) is the fraction of recycled products and u(k)=Ñᵢₙₜ(k)+Ñᵢₙⱼ(k) is the input mole vector Ñᵢₙₜ(k)=(k)ñᵢₙₜ(k) [0 μ_{O2} μ_{N2} 0 0]^{T}=ñᵢₙₜ(k)=Ñᵢₙₜ is the intake mole vector, where ñᵢₙₜ is the total of moles of intake and μ_{O2} and μ_{N2} denote the mole fractions of oxygen and nitrogen in the atmosphere, respectively.
Ñᵢₙⱼ(k)=ñᵢₙⱼ(k) [1 0 0 0 0]^{T}=ñᵢₙⱼ(k)=Ñᵢₙⱼ is the injection mole vector, where ñᵢₙⱼ is the total moles of injected fuel.

$$P ( k ) = [ \begin{matrix}{ε}_{c} ( k ) & 0 & 0 & 0 & 0 \\ - ( a + b / 4 ) ( 1 - {ε}_{c} ( k ) ) & 1 & 0 & 0 & 0 \\ 0 & 0 & 1 & 0 & 0 \\ a ( 1 - {ε}_{c} ( k ) ) & 0 & 0 & 1 & 0 \\ \frac{b}{2} ( 1 - {ε}_{c} ( k ) ) & 0 & 0 & 0 & 1\end{matrix} ] \qquad ( 5 )$$

is the reaction matrix obtained directly from (1).

Additionally, P₀=P|_{εc}=0 is defined as the nominal reaction matrix, corresponding to a full fuel burn, so that P(k)=(1−_{εc}(k))P₀+_{εc}(k)I. Letting B=[Ñᵢₙₜ Ñᵢₙⱼ], the mass balance takes the simple form

$$\begin{matrix}{N}_{c} ( k ) = P ( k ) ( β ( k ) {N}_{c} ( k - 1 ) + {N}_{int} ( k ) + {N}_{inj} ( k ) ) \\ = β ( k ) P ( k ) {N}_{c} ( k - 1 ) + P ( k ) B [ \begin{matrix}{n}_{int} ( k ) \\ {n}_{inj} ( k )\end{matrix} ] .\end{matrix} \qquad ( 6 )$$

Since the fraction of recycled products is controlled from cycle-to-cycle, β(k) is an input and in general the model is nonlinear. However, one might view (6) as a time-invariant linear system when β(k) and ε_{c}(k) are constant.

Simplified Thermodynamic Model

The combustion, gas exchange, injection, and compression/expansion processes are now approximated with simplified thermodynamic mechanisms. In addition to the mole vector state N, and temperature (in Kelvin), T, an additional state and a pressure p (Pa) are introduced. V is the cylinder volume. The notation in this section follows specific events in the engine as described earlier, where state variables can change.

Given N and T, the pressure in the cylinder is assumed to be given by the ideal gas law, pV=1^{T} NRT, where 1^{T}=[1 . . . 1]. For some vector xεRⁿ,1^{T} x=Σᵢ₌₁ⁿxᵢ so that 1^{T}N is the total number of moles of (ideal) gas. Similarly, the specific heat vectors Cₚ(T) and Cᵥ(T), the constant-pressure and constant-volume specific heat, respectively, are defined. Then, Cₚ^{T}N/1^{T} N denotes the constant-pressure specific heat of the in-cylinder gas mixture. Under the ideal gas assumption, Cₚ−Cᵥ=1R. Finally, the molar enthalpy vector is approximated with a constant specific heat as H(T)=Δ_{f}H+(T−T_{ref})Cₚ, where Δ_{f}H is the molar enthalpy of formation vector and T_{ref} is a reference temperature corresponding to the heat of formation.

The sequence of thermodynamic events in the cylinder during one nominal engine cycle as shown in FIG. 1 is as follows.

1. Post-combustion (c+) to exhaust valve opening (EVO): isentropic expansion.
2. EVO to exhaust valve closure (EVC): Isentropic, constant pressure expansion of exhaust gases to atmospheric conditions.
3. EVC to pre-injection (IOI−—“instant of injection”): Isentropic compression/expansion. Typically, the injection is after top dead center (TDC).
4. IOI− to post-injection (IOI+): instantaneous injection
5. IOI+ to intake valve opening (IVO): Isentropic expansion
6. IVO to intake valve closure IVC: Isentropic, constant pressure induction of gases.
7. IVC to pre-combustion (c−): Isentropic compression
8. c− to c+: constant-volume combustion with partial heat loss

The evolution of the states from process to process is now calculated. For any event E (e.g. E=IVC), V_{E} denotes the cylinder volume at that event. During injection and combustion, V is assumed to remain constant and the distinction between the “pre” and “post”-event V in notation will be dropped.

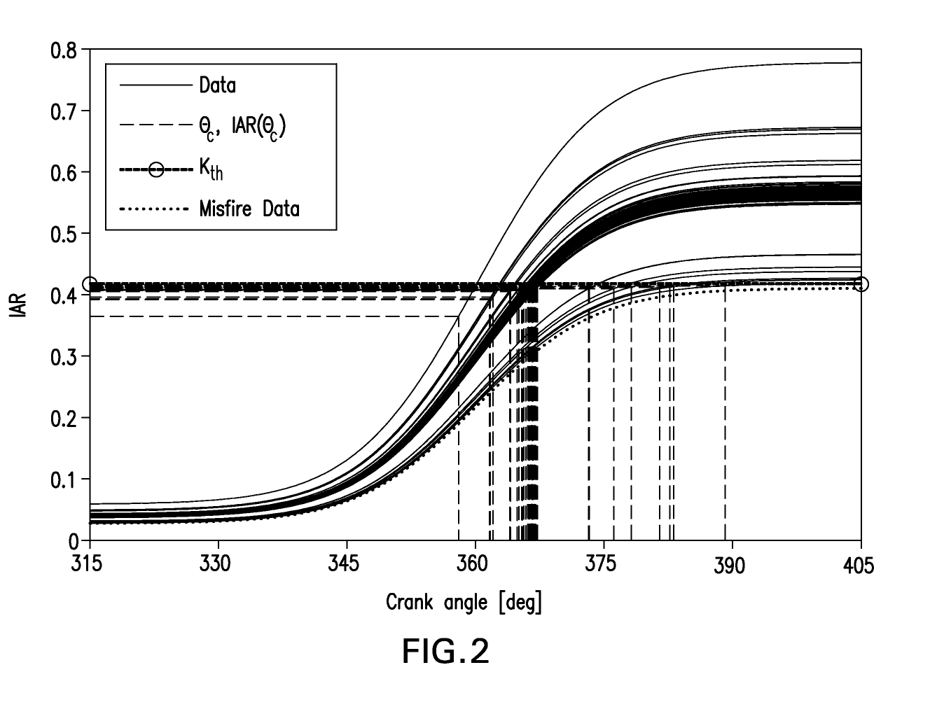

Finally, the state IAR mentioned earlier, is defined as

$$I A R ( θ ) {=}^{Δ} {\int }_{{θ}_{1}}^{θ} A {{exp ( - \frac{{E}_{a}}{RT ( θ )} ) [ {C}_{a} {H}_{b} ]}^{{σ}_{1}} [ {O}_{2} ]}^{{σ}_{2}} d θ + I A R ( {θ}_{1} ) , \qquad ( 7 )$$

where A, Eₐ, σ₁, and σ₂ are parameters of the combustion reaction rate, [S] is the concentration of species S given by N^{S}(θ)/V(θ), and V(θ) is given by the familiar cylinder volume formula. The temperature variation T is determined by polytropic relations. For example, given the temperature at IOI+, the temperature at any angle θε[IOI+, IVO] is calculated by T(θ)=(V(θ)/V_{IOI})^{γ-1}T_{IOI}+. The IAR yields in some sense, the rate to which the reaction has proceeded up to crank angle θ. In particular, if IAR(EVO)≧Kₜₕ, where Kₜₕ represents a threshold, then a complete combustion occurs. On the other hand, if IAR(EVO)<Kth, then there is a misfire; see FIG. 2. Furthermore, the combustion phasing, CA50, of the combustion process is determined by the crank angle at which IAR=Kₜₕ. The threshold can be different in the region between steps 2-5, 6-9 and 10-1.

The IAR parameters for a typical engine are shown in Table 1:

TABLE 1
Value of identified IAR parameters.

| | Parameter | | | | |
|---|---|---|---|---|---|
| | Kₜₕ | A | Eₐ | σ₁ | σ₂ |
| Value | 0.4169 | 10⁷ | 1.060 × 10⁵ | 0.6709 | 0.2570 |

FIG. 2 provides a graphical validation of the identification, showing the values of IAR(θ) for different initial conditions, the combustion phasing angles and the projected value of IAR(θ) for various data points, the value of Kₜₕ, and a data point that resulted in a misfire. In this case, the value of IAR did not reach Kₜₕ.

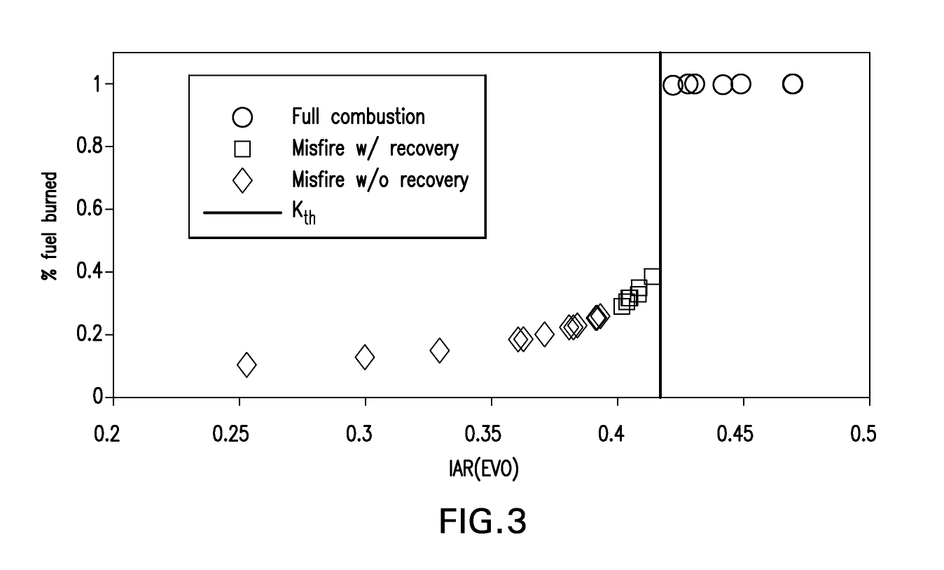

Also, the amount of fuel that is consumed in the reaction at the crank angle θ is a function of the IAR (see FIG. 3). In this respect, the following relationship physically based upon the IAR function is proposed:

ε_{c}(θ)=Φ(IAR(θ)), (8)

where φ(x): R→[0, 1] is continuous, non-increasing, Φ(x)=0 for all x≧Kₜₕ, and Φ(x)−1 as x→0. For example, when IAR(EVO)≧Kₜₕ, ε_{c}=0; however, if a misfire occurs (IAR(EVO)≧Kₜₕ), then ε_{c}ε(0, 1] Note that similar to the threshold, the function Φ can be different between steps 2-5, 6-9 and 10-1.

In further regard to FIG. 3, this figure shows the fraction of fuel burned vs. IAR(EVO). As IAR(EVO) increases, more fuel is consumed, until IAR(EVO)≧Kₜₕ. Thereafter, all the fuel is consumed. The % fuel burned (Y-axis) is equal to 1−ε_{c}. The circles are data points that exhibited a normal, full combustion. The squares are data points where a misfire occurred, but combustion occurred in the trapping phase. The diamonds are data points where there was a misfire and no combustion in the trapping phase.

As mentioned before, for purpose of illustration, step 1 in FIG. 1 is the starting point. Thus, suppose that T_{c+}, N_{c+} and IAR_{c+} from the last cycle is known. In the following subsections, the evolution of the states T_{X}, N_{X} and IAR_{X} as the engine runs its cycle is tracked, where X denotes any of the twelve points on the cycle as shown in FIG. 1.

Step 1: c⁺→EVO

In this case,

T_{EVO}=(V_{EVO}/V_{c}_{⁺})^{γ-1}T_{c}_{⁺}, (9)

where γ is the polytropic coefficient and

N_{EVO}=N_{c}_{⁺},IAR_{EVO}=IAR_{c}_{⁺}. (10)

Step 2: EVO→EVC

The exhaust event is assumed to expand the gas in the cylinder to atmospheric conditions isentropically and under constant pressure. The temperature evolution is given by

$${T}_{EVC} = {( {p}_{EXH} / {p}_{EVO} )}^{\frac{γ - 1}{γ}} {T}_{EVO} , \qquad ( 11 )$$

where p_{EXH} is the measured pressure of the exhaust manifold (or assumed to be atmospheric) and p_{EVO}=1^{T}N_{EVO}RT_{EVO}/V_{EVO.}

Let

$${\tilde{V}}_{EVC} = \frac{{1}^{T} {N}_{EVO} {RT}_{EVC}}{{p}_{EVC}} = \frac{{1}^{T} {N}_{EVO} {RT}_{EVC}}{{p}_{EXH}} \qquad ( 12 )$$

denote the volume of expanded gas so that the moles of gas after exhaust is given by

N_{EVC}=(V_{EVC}/\tilde{V}_{EVC})N_{EVO}. (13)

Finally,

IAR_{EVC}=IAR_{EVO}. (14)

Step 3: EVC→TP,c⁻

In this case, the crank angle that TP,c⁻ corresponds to is first identified. To find this, compute

$$IAR ( θ ) = {\int }_{EVC}^{θ} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{EVC} , \qquad ( 15 )$$

where [CₐH_{b}]=N_{EVC}^{C}^{ₐ}^{H}^{_{b}}/V(θ), [O₂]=N_{EVC}^{O}^{₂}/V(θ), and V(θ) is given by the familiar cylinder volume formula. The temperature at any angle θε[EVC, IOI⁻] is calculated by T(θ)=V(θ)/V_{EVC})^{γ-1}T_{EVC}. Let K_{th, 2} be the pre-specified threshold in this region. If IAR(IOI⁻)≧K_{th, 2}, then TP, c⁻=IAR⁻¹(K_{th, 2}) or else, TP, c⁻=IOI⁻.

Once the crank angle TP, c⁻ is identified, then

$$\begin{matrix} {T}_{TP , {c}^{-}} = {( {V}_{TP , {c}^{-}} / {V}_{EVC} )}^{γ - 1} {T}_{EVC} , & ( 16 ) \\ {N}_{TP , {c}^{-}} = {N}_{EVC} , & ( 17 ) \\ {IAR}_{TP , {c}^{-}} = {\int }_{EVC}^{TP , {c}^{-}} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{EVC} . & ( 18 )\end{matrix}$$

Step 4: TP, c⁻→TP, c⁺

In this case, compute ε_{c}=Φ(IAR_{TP,c}_{^{−}}) as given in (8) and P as given in (5) for the computed εc. Then,

N_{TP,c}_{⁺}=PN_{TP,c}_{^{−}}, (19)

IAR_{TP,c}_{⁺}=IAR_{TP,c}_{^{−}}. (20)

To compute temperature, a constant-volume combustion is assumed, and a modified energy balance is used, where some heat generated by the combustion is lost to the engine surroundings, in terms of the “lower heating value” of our fuel. For the purposes of this discussion, it is defined as

LHV_{CaHb}=−[1 0 0 0 0](P₀−I)^{T}Δ_{f}H

Multiplied by the number of moles of fuel burned, LHV_{C}_{ₐ}_{H}_{_{b}} gives us the amount of heat produced by this exothermic combustion. Note that with this definition, LHV_{C}_{ₐ}_{H}_{_{b}} is indeed positive, since the enthalpy of the products is lower than the enthalpy of the reactants. Note also, that from the structure of P₀−I, LHV_{C}_{ₐ}_{H}_{_{b}}=−Δ_{f}H^{T}(P₀−I)[1*]^{T}, where * is any vector with 4 components. Letting U_{TP,c-} and U_{TP,c+} denote the internal energy of the in-cylinder gas mixtures before and after combustion, respectively, and letting ε_{c}, denote the fraction of heat generated by combustion that is lost to the cylinder wall, the following equation is obtained:

U_{TP,c-}−ε_{Q}(1−ε_{c})LHV_{CaHb}N_{TP,c-}^{C}^{ₐ}^{H}^{_{b}}=U_{TP,c+}. (21)

Then, using the definition of enthalpy U=H−pV, exploiting the ideal gas law, recalling that H(T)=Δ_{f}H+(T−T_{ref})Cₚ, using the fact that N_{TP,c+}═N_{TP,c-}, and noting that (1−ε_{c})(P₀−1)=(P−I), equation (21) is expanded into

Δ_{f}H^{T}N_{TP,c-}+(T_{TP,c-}−T_{ref})Cₚ^{T}N_{TP,c-}−1^{T}N_{TP,c-}RT_{TP,c-}−ε_{Q}Δ_{f}H^{T}(P−I)N_{TP,c-}=Δ_{f}H^{T}PN_{TP,c+}+(T_{TP,c+}−T_{ref})Cₚ^{T}PN_{TP,c-}−1^{T}PN_{TP,c-}RT_{TP,c+}. (22)

Solving for T_{TP,c+}, grouping terms, and noting that Cₚ−1R═Cᵥ, the following is obtained:

$${T}_{TP , {c}^{+}} = \frac{[ ( ( {∈}_{Q} - 1 ) {Δ}_{f} {H}^{T} + {T}_{ref} {C}_{p}^{T} ) ( P - I ) + {T}_{TP , {c}^{-}} {C}_{v}^{T} ] {N}_{TP , {c}^{-}}}{{C}_{v}^{T} {N}_{TP , {c}^{-}}} \qquad ( 23 )$$

Step 5: TP, c⁺→IOI⁻

In this case,

T_{IOI}_{^{−}}=(V_{IOI}_{^{−}}/V_{TP,c}_{⁺})^{γ-1}T_{TP,c}_{⁺}, (24)

where γ is the polytropic coefficient and

$$\begin{matrix}{N}_{{IOI}^{-}} = {N}_{TP , {c}^{+}} , \\ and & ( 25 ) \\ {IAR}_{{IOI}^{-}} = {\int }_{TP , {c}^{+}}^{{IOI}^{-}} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{TP , {c}^{+} ,} & ( 26 )\end{matrix}$$

where [CₐH_{b}]=N_{TP,c}_{⁺}^{C}^{ₐ}^{H}^{_{b}}/V(θ), [O₂]=N_{TP,c}_{⁺}^{O}^{₂}/V(θ), and V(θ) is given by the familiar cylinder volume formula. The temperature at any angle θε[TP, c⁺, IOI⁻] is calculated by T(θ)=(V(θ)/V_{TP,c+})^{γ-1}T_{TP,c+}.

### Step 6: IOI⁻→IOI⁺

The injection event is modeled as a constant-volume process, where the final temperature is calculated using standard energy balance calculations. Let Δᵥₐₚh_{C}_{ₐ}_{H}_{_{b}}, denote the heat of vaporization of the fuel and let Tᵢₙⱼ denote the temperature of the injected liquid fuel. Assuming instant vaporization of the fuel, then

Cᵥ^{T}(N_{IOI-}+Nᵢₙⱼ)T_{IOI+}=TᵢₙⱼCᵥ^{T}Nᵢₙⱼ+T_{IOI-}Cᵥ^{T}N_{IOI-}−Δᵥₐₚh_{C}_{ₐ}_{H}_{_{b}}ηᵢₙⱼ (27)

Thus, the following equations are obtained:

$$\begin{matrix}{T}_{IOI +} = \frac{{T}_{inj} {C}_{v}^{T} {N}_{inj} + {T}_{IOI -} {C}_{v}^{T} {N}_{IOI -} - {Δ}_{vap} {h}_{{C}_{a} {H}_{b}} {n}_{inj}}{{C}_{v}^{T} ( {N}_{IOI -} + {N}_{inj} )} , & ( 28 ) \\ {N}_{IOI +} = {N}_{IOI -} + {N}_{inj} , & ( 29 ) \\ {IAR}_{IOI +} = {IAR}_{IOI -} . & ( 30 )\end{matrix}$$

Step 7: IOI⁺→PI, c⁻

In this case, the crank angle that PI, c⁻ corresponds to is first identified. To find this, compute

$$IAR ( θ ) = {\int }_{IOI +}^{θ} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{IOI +} , \qquad ( 31 )$$

where [CₐH_{b}]=N_{IOI}_{⁺}^{C}^{ₐ}^{H}^{_{b}}/V(θ), [O₂]=N_{IOI}_{⁺}^{O}^{₂}V(θ), and V(θ) is given by the familiar cylinder volume formula. The temperature at any angle θε[IOI⁺, IVO] is calculated by T(θ)=(V(θ)/V_{IOI+})^{γ-1}T_{IOI+}. Let K_{th,1}≧IAR_{IOI+} be the pre-specified threshold in this region. If IAR(IVO)≧K_{th,1}, then TP, c⁻=IAR⁻¹(K_{th,1}) or else, TP, c⁻=IVO.

Once the crank angle PI, c⁻ is identified, then

$$\begin{matrix}{T}_{PI , c -} = {( {V}_{PI , c -} / {V}_{IOI +} )}^{γ - 1} {T}_{IOI +} , & ( 32 ) \\ {N}_{PI , c -} = {N}_{IOI +} , & ( 33 ) \\ {IAR}_{PI , c -} = {\int }_{IOI +}^{PI , c -} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{IOI +} . & ( 34 )\end{matrix}$$

Step 8: PI,c⁻→PI, c⁺

As formulated in step 4, compute ε_{c}=Φ(IAR_{PI, c-}) as given in (8) and P as given in (5) for the computed ε_{c}. Then,

$$\begin{matrix}{T}_{TP , {c}^{+}} = \frac{[ ( ( {∈}_{Q} - 1 ) {Δ}_{f} {H}^{T} + {T}_{ref} {C}_{p}^{T} ) ( P - I ) + {T}_{TP , {c}^{-}} {C}_{v}^{T} ] {N}_{PI , {c}^{-}}}{{C}_{v}^{T} {N}_{TP , {c}^{-}}} & ( 35 ) \\ {N}_{PI , c +} = {PN}_{PI , c -} , & ( 36 ) \\ {IAR}_{PI , c +} = {IAR}_{PI , c -} , & ( 37 )\end{matrix}$$

where ε_{Q} denotes the fraction of heat generated by combustion that is lost to the cylinder wall and Δ_{f}H was defined in step 4.

Step 9: PI, c⁺→IVO

In this case,

T_{IVO}=(V_{IVO}/V_{PI,c}_{^{−}})^{γ-1}T_{PI,c}_{⁺}, (38)

where γ is the polytropic coefficient and

$$\begin{matrix}{N}_{IVO} = {N}_{IOI +} , \\ and & ( 39 ) \\ {IAR}_{IVO} = {\int }_{PI , c +}^{IVO} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{PI , c +} . & ( 40 )\end{matrix}$$

where [CₐH_{b}]=N_{PI,c}_{⁺}^{C}^{ₐ}^{H}^{_{b}}/V(θ), [O₂]=N_{PI,c}_{⁺}^{O}^{₂}/V(θ), and V(θ) is given by the familiar cylinder volume formula. The temperature at any angle θε[PI,c⁺, IVO] is calculated by T(θ)=(V(θ)/V_{PI,c}_{⁺})^{γ-1}T_{PI,c+}.

Step 10: IVO→IVC

The intake model relies on an isentropic, constant-pressure induction of atmospheric gases. When the intake valve opens at IVO, the in-cylinder gas is assumed to instantly expand/contract to the conditions at the intake manifold. Then, up until IVC or bottom-dead-center (BDC), the contracted in-cylinder gas is assumed to mix with atmospheric gases that fill the void in the cylinder. Because both the post-intake temperature and the number of moles of intake are unknown, the two must be solved for jointly (unless other, simplifying assumptions are made).

First, let X=min(IVC, BDC), i.e., X is the event that comes first: intake valve closure, or the piston reaching bottom-dead-center. The temperature and volume of the in-cylinder gas expanded/compressed to the conditions at the intake manifold are calculated using an isentropic expansion/compression.

$${\tilde{T}}_{X} = {( \frac{{p}_{int}}{{p}_{IVO}} )}^{\frac{γ - 1}{γ}} {T}_{IVO} \\ {\tilde{V}}_{X} = \frac{{\tilde{T}}_{X} R {1}^{T} {N}_{IVO}}{{p}_{int}} \qquad ( 41 )$$

Then, the mole vector at event X is

Nₓ═N_{IVO}+ N̅ᵢₙₜnᵢₙₜ=N_{IVO}+Nᵢₙₜ. (42)

A simple energy balance yields the relationship between the moles of intake and the post-intake temperature as

\tilde{P}_{X}Cₚ^{T}N_{IVO}TᵢₙₜCₚ^{T}Nᵢₙₜ=T_{X}Cₚ^{T}(N_{IVO}Nᵢₙₜ). (43)

Invoking the ideal gas assumption relates T_{X} to Nᵢₙⱼ by

$${T}_{X} = \frac{{p}_{int} {V}_{X}}{R {1}^{T} ( {N}_{IVO} + {N}_{int} )} . \qquad ( 44 )$$

Then, substituting (44) into (43), one obtains

$${\tilde{T}}_{X} {C}_{p}^{T} {N}_{IVO} + {T}_{int} {C}_{p}^{T} {N}_{int} = \frac{{p}_{int} {V}_{X}}{R {1}^{T} ( {N}_{IVO} + {N}_{int} )} {C}_{p}^{T} ( {N}_{IVO} + {N}_{int} ) . \qquad ( 45 )$$

Factoring out nᵢₙₜ and grouping terms in (45), one obtains

nᵢₙₜ²t(TᵢₙₜCₚ^{T} N̅ᵢₙₜR1^{T} N̅ᵢₙₜ)+nᵢₙₜ(\tilde{T}_{X}Cₚ^{T}N_{IVO}R1^{T} N̅ᵢₙₜ+TᵢₙₜCₚ^{T} N̅ᵢₙₜR1^{T}N_{IVO}−pᵢₙₜV_{X}Cₚ^{T} N̅ᵢₙₜ)+(\tilde{T}_{X}Cₚ^{T}N_{IVO}R1^{T}N_{IVO}−pᵢₙₜV_{X}Cₚ^{T}N_{IVO})=0. (46)

Thus, to solve for Tₓ and nᵢₙₜ jointly, the quadratic equation (45) must be solved for nᵢₙₜ.

For this intake event to make physical sense, equation (46) must have two real roots, either with one positive and one negative, or a double-root at zero. Certainly, having two positive roots or two negative roots, one could not make sense of the solution. Letting anᵢₙₜ²+bnᵢₙₜ+c=0 denote (46), the following conditions must be satisfied: b²−4ac>0 (guaranteeing real roots) and |b|<\sqrt{b²−4ac}. Note that these two conditions are satisfied when a>0 and c<0.

Examining a, it follows that a=TᵢₙₜCₚ^{T} N̅ᵢₙₜR1^{T} N̅ᵢₙₜ>0. Then, for c<0, the following must be satisfied:

c=\tilde{T}_{X}RCₚ^{T}N_{IVO}1^{T}N_{IVO}−pᵢₙₜV_{X}Cₚ^{T}N_{IVO}<0.

Factoring Cₚ^{T}N_{IVO}>0 from the left hand side and recalling from (41) that pᵢₙₜ\tilde{V}_{X}=\tilde{T}_{X}R1^{T}N_{IVO}, it follows that

\tilde{V}_{X}<V_{X}. (47)

That is, when the in-cylinder gas at IVO is expanded/compressed isentropically to the conditions at X, the volume of the cylinder must be large enough to hold this volume of gas. Only then can a positive amount of gas from the atmosphere fill the “void” in the cylinder.

With this calculation in hand, if IVC≦BDC, then this concludes the intake model, otherwise (having X=BDC), the intake model is completed by assuming that by BDC, the gases have reached an equilibrium temperature, and since the volume decreases after BDC, the mixed in-cylinder gas is simply pushed out of the cylinder so that

$$\begin{matrix}{T}_{IVC} = {T}_{BDC} = {T}_{X} , {N}_{IVC} = {N}_{BDC} ( \frac{{V}_{IVC}}{{V}_{BDC}} ) , \\ and & ( 48 ) \\ {IAR}_{IVC} = {IAR}_{IVO} . & ( 49 )\end{matrix}$$

Step 11: IVC→c⁻

In this case, the crank angle that c⁻ corresponds to is first identified by computing

$$IAR ( θ ) = {\int }_{IVC}^{0} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{IVC} , \qquad ( 50 )$$

where [CₐH_{b}]=N_{IVC}^{C}^{ₐ}^{H}^{_{b}}/V(θ), [O₂]=N_{IVC}^{O}^{₂}/V(θ), and V(θ) is given by the familiar cylinder volume formula. The temperature at any angle θε[IVC, EVO] is calculated by T(θ)=V(θ)/V_{IVC})^{γ-1}T_{IVC}). Let Kₜₕ be the pre-specified threshold in this region. If IAR(EVO)≧Kₜₕ, then c⁻=IAR⁻¹(Kₜₕ). Otherwise, c⁻=EVO and a misfire occurs.

Once the crank angle c⁻ is identified, then

$$\begin{matrix}{T}_{c -} = {( {V}_{c -} / {V}_{IVC} )}^{γ - 1} {T}_{IVC} , & ( 51 ) \\ {N}_{c -} = {N}_{IVC} , & ( 52 ) \\ {IAR}_{c -} = {\int }_{IVC }^{c -} A {{exp ( - \frac{{E}_{a}}{RT ( θ )} ) [ {C}_{a} {H}_{b} ]}^{{σ}_{1}} [ {O}_{2} ]}^{{σ}_{2}} d θ + {IAR}_{IVC} . & ( 53 )\end{matrix}$$

Step 12:c⁻→c⁺

As formulated in step 4, ε_{c}=Φ(IAR_{c-}) is computed as given in (8), and P is computed as given in (5) for the computed ε_{c}. Then,

$$\begin{matrix}{T}_{{c}^{+}} = \frac{[ ( ( {∈}_{Q} - 1 ) {Δ}_{f} {H}^{T} + {T}_{ref} {C}_{p}^{T} ) ( P - I ) + {T}_{{c}^{-}} {C}_{v}^{T} ] {N}_{{c}^{-}}}{{C}_{v}^{T} {N}_{{c}^{-}}} & ( 54 ) \\ {N}_{c +} = {PN}_{c -} , & ( 55 ) \\ {IAR}_{c +} = {IAR}_{c -} , & ( 56 )\end{matrix}$$

where ε_{Q} denotes the fraction of heat generated by combustion that is lost to the cylinder wall and Δ_{f}H was defined in step 4.

Example Simulation Results for the Method

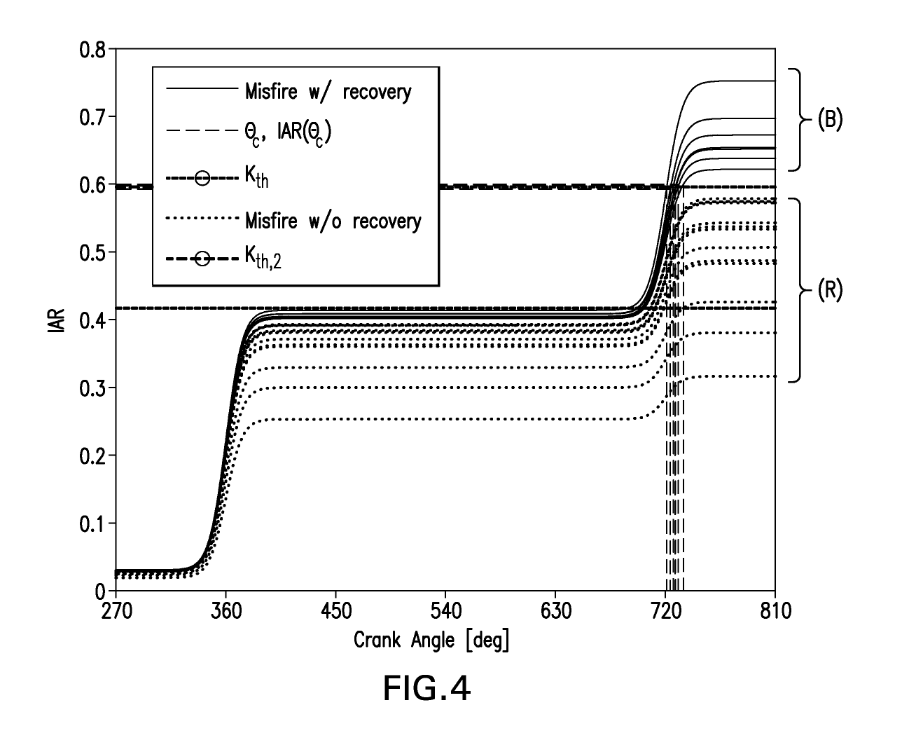

FIG. 4 shows the value of IAR with the parameters in Table 1 as a function of the crank angle in degrees. All curves represented on this figure are the result of a misfire in the first cycle (note that the value of IAR(θ)<Kₜₕ during the nominal compression/expansion strokes). During the compression stroke in the trapping phase, the integrand of IAR takes on a highly positive value again and for some trajectories, combustion occurs in the trapping phase, where IAR(θ)≈K_{th,2}=0.5958. Lines denoted by reference character (B) in FIG. 4 are data points where a misfire occurred, but a combustion occurred in the trapping phase (recovery); lines denoted by reference character (R) in FIG. 4 are data points where a misfire occurred without a trapping phase combustion.

As described earlier, in case of misfire, instead of decreasing the amount of EGR, it is necessary to increase the amount of EGR to keep more thermal energy inside of the cylinder. The following control inputs can improve the misfire recovery behavior. These control inputs are necessary to introduce the desirable transitions from misfire state to a nominal operating case.
For misfire with minor heat release: A late injection to avoid full combustion during the trapping cycle, and a reduction in amount of injected fuel to account for residual fuel of the previous cycle.
For misfire with no heat release: An earlier exhaust valve closing to trigger combustion of residual fuel within the trapping cycle, and a later injection and reduction of injected fuel to account for residual fuel of the previous cycle.

The increased EGR in the above control strategy makes combustion within the trapping cycle possible, and therefore the system recovers to a nominal operating case eventually. Depending on the initial conditions, the nominal value may be reached within the third cycle. Thus, the region of recovery for an HCCI engine from misfire can be increased. In the absence of the feedback strategy described above, the engine might stall.

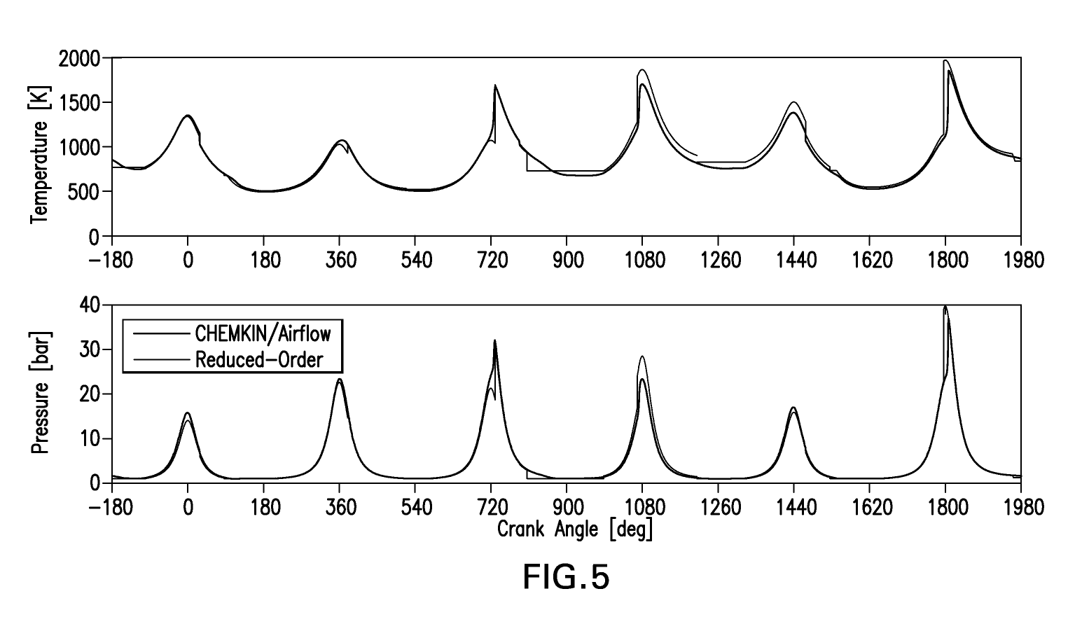

FIG. 5 shows a comparison between the high-fidelity CHEMKIN/Airflow simulation model in K L. Knierim, Sungbae Park J. Ahmed, A. Kojic, I Orlandini and A. Kulzer: “Simulation of misfire and strategies form is fire recovery of gasoline HCCI,” Proceedings of the 2008 American Control Conference, pages 3947-3952, (2008) and the method of the present application using control inputs that caused a misfire, then a recovery. In this comparison, the reduced-order model was only given the same initial condition as the CHEMKIN/Airflow model. Only ε_{Q}, the fraction of heat lost to the engine surroundings, was tuned so that the models would match reasonably well.

What is claimed is:

1. A method for predicting and correcting an impending misfire in a homogeneous charge compression ignition (HCCI) engine, comprising:
modeling HCCI engine operation in a nominal, steady-state operating region and in unstable operating regions bordering the steady-state operating region, using a zero-dimensional model;
based on the modeling of the HCCI engine operation, predicting an occurrence of an engine misfire; and
in the case an engine misfire is predicted, providing a remedial corrective measure.

2. The method of claim 1, wherein the modeling of HCCI engine operation includes performing a mass balance of chemical species present in a combustion chamber of a cylinder of the HCCI engine at a plurality of points in a combustion cycle of the HCCI engine.

3. The method of claim 2, wherein the chemical species include CₐH_{b}, O₂, N₂, CO₂ and H₂O.

4. The method of claim 3, wherein the points in the combustion cycle of the HCCI engine include:
a1) exhaust valve opening;
b) exhaust valve closing;
c) trapping phase before combustion;
d) trapping phase after combustion;
e) before instant of injection;
f) after instant of injection;
g) post-injection/pre-intake, before combustion;
h) post-injection/pre-intake, after combustion;
i) intake valve opening;
j) intake valve closing;
k) before combustion; and
l) after combustion.

5. The method of claim 4, wherein the mass balance takes into account a partial burn of fuel during the combustion cycle.

6. The method of claim 4, wherein the mass balance is performed according to the following relationships:
φCₐH_{b}+(a+b/4)O₂→φε_{c}CₐH_{b}+(a+b/4)(1−φ(1−ε_{c}))O₂+aφ(1−ε_{c})CO₂+(b/2)φ(1−ε_{c})H₂O (1)
Nᵣ(k)=β(k)N_{c}(k−1) (2)
Nₘ(k)=Nᵣ(k)+u(k) (3)
N_{c}(k)=P(ε_{c}(k))Nₘ(k), (4)
wherein:
N is a mole vector indicating the moles of the chemical species;
k is a combustion cycle;
φ(k)ε[0,1] is a ratio of fuel moles to a stoichiometric value;
εₑ(k)ε[0,1] is a disturbance factor indicating partial burn, ε_{c}(k)=0 indicating complete combustion;
N_{c}(k−1) is the mole vector after combustion in a previous cycle;
Nᵣ(k) is the mole vector indicating the remaining, recycled moles of chemical species after product is exhausted from the combustion chamber;
β(k) is a fraction of recycled products;
u(k) is a vector indicating additional fuel from injection and air from intake;
Nₘ(k) is the mixed, pre-combustion mole vector;
N_{c}(k) is the post-combustion mole vector; and
P(k) is a reaction matrix obtained from relationship (1).

7. The method of claim 1, wherein the modeling of HCCI engine operation includes thermodynamically modeling combustion, gas exchange, injection, and compression/expansion processes of chemical species in a combustion chamber of a cylinder of the HCCI engine at selected points in a combustion cycle of the HCCI engine.

8. The method of claim 7, wherein the chemical species include CₐH_{b}, O₂, N₂, CO₂ and H₂O.

9. The method of claim 8, wherein the points in the combustion cycle of the HCCI engine include:
a) exhaust valve opening;
b) exhaust valve closing;
c) trapping phase before combustion;
d) trapping phase after combustion;
e) before instant of injection;
f) after instant of injection;
g) post-injection/pre-intake, before combustion;
h) post-injection/pre-intake, after combustion;
i) intake valve opening;
j) intake valve closing;
k) before combustion; and
l) after combustion.

10. The method of claim 9, wherein the thermodynamic modeling of the combustion, gas exchange, injection, and compression/expansion processes takes into account a partial burn of fuel during the combustion cycle.

11. The method of claim 9, wherein the combustion, gas exchange, injection, and compression/expansion processes of the chemical species in the combustion chamber of the cylinder of the HCCI engine are thermodynamically modeled, using the following relationships:
$$pV = {1}^{T} NRT \\ {C}_{p} ( T ) - {C}_{v} ( T ) = {1}^{T} R \\ H ( T ) = {Δ}_{f} H + ( T - {T}_{ref} ) {C}_{p} \\ IAR ( θ ) {=}^{Δ} {\int }_{{θ}_{1}}^{θ} A {{exp ( - \frac{{E}_{a}}{RT ( θ )} ) [ {C}_{a} {H}_{b} ]}^{{σ}_{1}} [ {O}_{2} ]}^{{σ}_{2}} d θ + IAR ( {θ}_{1} ) , \qquad ( 7 )$$
wherein:
p is a pressure in the cylinder;
V is a volume of the cylinder;
1^{T} is a matrix corresponding to [1 . . . 1]
N is a mole vector indicating the moles of the chemical species;
R is an ideal gas constant;
T is a temperature of the chemical species in the cylinder;
Cₚ(T) is a constant-pressure specific heat vector;
Cᵥ(T) is a constant-volume specific heat vector;
H(T) is a molar enthalpy vector;
Δ_{f}H is a molar enthalpy of formation vector;
T_{ref} is a reference temperature corresponding to a heat of formation;
IAR(θ) is an integrated Arrhenius rate corresponding to a rate at which a reaction of the chemical species in the cylinder has proceeded up to crank angle θ;
A, Eₐ, θ₁ and σ₂ are parameters of a combustion reaction rate;
[CₐH_{b}] is a concentration of species CₐH_{b} in the cylinder; and
[O₂] is a concentration of species O₂ in the cylinder.

12. The method of claim 11, wherein if a value of IAR at a crank angle θ corresponding to exhaust valve opening is greater than or equal to a threshold value Kₜₕ, then complete combustion is determined to have occurred in the cylinder, and if a value of IAR at a crank angle θ corresponding to exhaust valve opening is less than threshold value Kₜₕ, then a misfire is determined to have occurred in the cylinder.

13. The method of claim 12, wherein in the case a misfire is determined to have occurred in the cylinder, performing one of: (a) late injection to avoid full combustion during a trapping cycle, and a reduction in amount of injected fuel to account for residual fuel of the previous cycle; or (b) earlier exhaust valve closing to trigger combustion of residual fuel within the trapping cycle, and a later injection and reduction of injected fuel to account for residual fuel of the previous cycle.

14. The method of claim 1, wherein the remedial corrective measure includes one of: (a) late injection to avoid full combustion during a trapping cycle, and a reduction in amount of injected fuel to account for residual fuel of the previous cycle; or (b) earlier exhaust valve closing to trigger combustion of residual fuel within the trapping cycle, and a later injection and reduction of injected fuel to account for residual fuel of the previous cycle.

15. A non-transitory computer-readable storage medium storing a computer program having program codes which, when executed on a computer, performs a method for predicting and correcting an impending misfire in a homogeneous charge compression ignition (HCCI) engine, the method comprising:
modeling HCCI engine operation in a nominal, steady-state operating region and in unstable operating regions bordering the steady-state operating region, using a zero-dimensional model;
based on the modeling of the HCCI engine operation, predicting an occurrence of an engine misfire; and
in the case an engine misfire is predicted, providing a remedial corrective measure.
